(19) United States
(12) Patent Application Publication
(10) Pub. No.: US 2020/0202253 A1
(43) Pub. Date: Jun. 25, 2020

(54) COMPUTER, CONFIGURATION METHOD, AND PROGRAM

(71) Applicant: FRONTEO, Inc., Tokyo (JP)

(72) Inventors: Ryota TAMURA, Tokyo (JP); Takafumi SEIMASA, Tokyo (JP); Kazumi HASUKO, Tokyo (JP); Akiteru HANATANI, Tokyo (JP); Shinya IGUCHI, Tokyo (JP)

(21) Appl. No.: 16/590,533

(22) Filed: Oct. 2, 2019

(30) Foreign Application Priority Data
Dec. 19, 2018 (JP) 2018-237649

(51) Int. Cl. G06N 20/00

(52) U.S. Cl. CPC G06N 20/00

(57) ABSTRACT

To construct a learned model exhibiting a high generalization capability. A data set is stored in a memory of a computer. A controller of the computer executes: sampling processing for sampling first learning data from the data set; clustering processing for generating a plurality of clusters by clustering data included in the data set; selection processing for selecting second learning data from a cluster not including the first learning data among the plurality of clusters; and configuration processing for configuring learning data set including the first learning data and at least a part of the second learning data as the learning data set.

### BACKGROUND OF THE INVENTION

### Field of the Invention

The disclosure relates to a computer, a configuration method, and a program for configuring learning data used for machine learning.

### Description of the Related Art

When data is processed by using a learned model, it is necessary to configure a learning data set used for machine learning. For example, for having an identifier that identifies a facial image (a picture including a face of a person as an image) learn facial images by a supervised learning scheme, it is necessary to construct a learning data set by collecting a great number of facial images and pairing correct identification results to each of the facial images.

In order to construct a learned model having a high generalization capability (for example, identification accuracy) capable of returning a correct output (for example, an identification result) for an unknown input (for example, a facial image), diversity of the learning data included in the learning data set is important. That is, it is necessary to configure the learning data set including the learning data collected thoroughly from a subject area where the learned model is to exhibit the generalization capability.

In order to secure the diversity, conventionally employed is an approach to configure a learning data set by randomly sampling a vast amount of data (Japanese Patent No. 5567049, issued on Aug. 6, 2014). It is because random sampling is the best way for minimizing statistical difference between a data group configuring the subject area and a learning data set when it is possible to collect a sufficient number of sets of learning data for an assumed range of the subject area (for example, kinds of facial images to be identified).

However, when a sufficient number of sets of learning data cannot be collected, it is difficult to secure the diversity of learning data. For example, when the cost for collecting learning data is high as in a case requiring assessments of experts (for example, a lawyer, a medical doctor, and the like) for creating supervised data indicating a correct identification result, the number of sets of learning data tends to become insufficient for the assumed range of the subject area. In such case, with simple random sampling from the data group configuring the subject area, data of a specific volume or less included in the data set group may be mis-fetched. Therefore, there is no guarantee that the statistical difference between the data group configuring the subject area and the learning data set can be minimized to a required accuracy. Thus, there is a possibility that the generalization capability of the learned model in the subject area cannot be increased sufficiently. Therefore, desired is a data set configuration method capable of constructing a learned model exhibiting a high generalization capability even in a case where the learning data cannot be collected sufficiently.

An aspect of the disclosure is designed in view of the above-described problem, and it is an object of the disclosure to achieve a learning data set construction method capable of constructing a learned model exhibiting a high generalization capability.

### SUMMARY OF THE INVENTION

In order to overcome the above-described problem, the computer according to an aspect of the disclosure is a computer configuring a learning data set used for machine learning, the computer including a memory and a controller, wherein: the memory includes a data set stored therein; and the controller executes sampling processing for sampling first learning data from the data set, clustering processing for generating a plurality of clusters by clustering data included in the data set, selection processing for selecting second learning data from a cluster not including the first learning data among the plurality of clusters, and configuration processing for configuring a learning data set including the first learning data and at least a part of the second learning data as the learning data set.

In order to overcome the above-described problem, the configuration method according to an aspect of the disclosure is a configuration method for configuring a learning data set used for machine learning by using a computer including a memory storing a data set and a controller, the method including: sampling processing executed by the controller for sampling first learning data from the data set; clustering processing executed by the controller for generating a plurality of clusters by clustering data included in the data set; selection processing executed by the controller for selecting second learning data from a cluster not including the first learning data among the plurality of clusters; and configuration processing executed by the controller for configuring a learning data set including the first learning data and at least a part of the second learning data as the learning data set.

In order to overcome the above-described problem, the computer according to an aspect of the disclosure is a computer configuring a learning data set for learning a model, the computer including a memory and a controller, wherein: the memory stores a data set; the data set includes at least a part of sets of unlabeled data having no label indicating whether or not a prescribed extraction condition is satisfied; the prescribed extraction condition is configured from a plurality of viewpoints to be a basis of determining whether or not the data satisfies the extraction condition; and the controller executes processing for configuring a review data set by sampling the unlabeled data from the data set, processing for generating a plurality of clusters by clustering the data included in the data set, and processing for supplementing the unlabeled data included at least in a part of the plurality of clusters to the review data set so as to decrease omission of the viewpoints.

According to an aspect of the disclosure, it is possible to achieve a learning data set construction method capable of constructing a learned model exhibiting a high generalization capability.

### BRIEF DESCRIPTION OF THE DRAWINGS

FIG. 1 is a block diagram illustrating a configuration of a computer according to a first embodiment of the disclosure;

FIG. 2 is a flowchart illustrating a flow of learning processing performed by using the computer illustrated in FIG. 1;

FIG. 3 is a flowchart illustrating a flow of data in a first half of the learning processing performed by using the computer illustrated in FIG. 1; and

FIG. 4 is a flowchart illustrating a flow of data in a latter half of the learning processing performed by using the computer illustrated in FIG. 1.

### DETAILED DESCRIPTION OF THE PREFERRED EMBODIMENTS

### (Configuration of Computer)

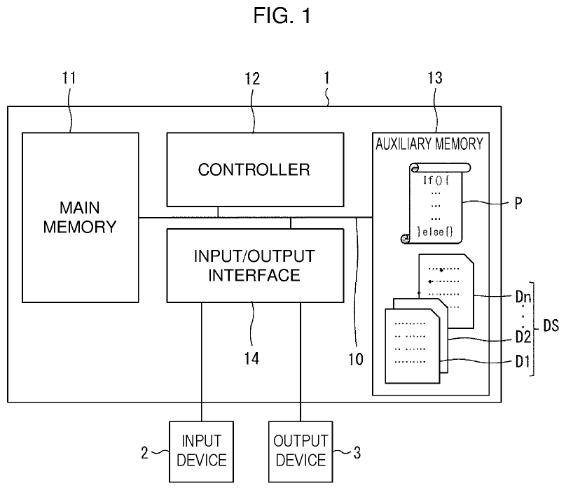

The configuration of a computer 1 according to an embodiment of the disclosure will be described by referring to FIG. 1. FIG. 1 is a block diagram illustrating an example of the configuration of the computer 1. Note that the configuration of the computer 1 illustrated in FIG. 1 is merely an example. As will be described later, each processing executed by the computer 1 may also be executed by a plurality of computers.

As illustrated in FIG. 1, the computer 1 includes a bus 10, a main memory 11, a controller 12, an auxiliary memory 13, and an input/output interface 14. The controller 12, the auxiliary memory 13, and the input/output interface 14 are connected mutually via the bus 10. As the main memory 11, a single or a plurality of semiconductor RAM (Random Access Memory) is used, for example. As the controller 12, a single or a plurality of CPU (Central Processing Unit) is used, for example. As the auxiliary memory 13, an HDD (Hard Disk Drive) is used, for example. As the input/output interface 14, a USB (Universal Serial Bus) interface is used, for example.

To the input/output interface 14, an input device 2 and an output device 3 are connected, for example. As the input device 2, a keyboard and a mouse are used, for example. As the output device 3, a display and a printer are used, for example. Like a laptop computer, the computer 1 may have a keyboard as well as a trackpad functioning as the input device 2 and a display functioning as the output device 3 built therein. Further, like a smartphone or a tablet computer, the computer 1 may have a touch panel functioning as the input device 2 and the output device 3 built therein.

In the auxiliary memory 13, stored is a program P for having the controller 12 perform learning processing S and machine review processing using a learned model M acquired by the learning processing S. The controller 12 expands the program P stored in the auxiliary memory 13 on the main memory 11 and executes each instruction included in the program P expanded on the main memory 11 to execute each step included in the learning processing S and the machine review processing. In the auxiliary memory 13, stored is a data set DS the controller 12 refers to when performing the learning processing S and the machine review processing. The data set DS is a set of at least a single set of data D1, D2, . . . , Dn (n is any natural number of 1 or larger). The controller 12 expands each set of data Di (i=1, 2, . . . , n) stored in the auxiliary memory 13 on the main memory 11, and refers thereto when performing the learning processing S and the machine review processing.

While there is described a mode where the computer 1 performs the learning processing S and the machine review processing by using the program P stored in the auxiliary memory 13 as an internal storage medium, the disclosure is not limited to that. That is, it is also possible to employ a mode where the computer 1 performs the learning processing S and the machine review processing by using the program P stored in an external recording medium. In such case, as the external recording medium, it is possible to use “non-transitory tangible medium” capable of being read by the computer 1, such as a tape, a disk, a card, a semiconductor memory, a programmable logic circuit, or the like. Alternatively, it is also possible to employ a mode where the computer 1 performs the learning processing S and the machine review processing by using the program P acquired via a communication network. In such case, as the communication network, it is possible to use the Internet, LAN, or the like, for example.

While the embodiment is described by referring to the mode where the learning processing S and the machine review processing are performed by using the single computer 1, the disclosure is not limited to such mode. That is, it is also possible to employ a mode that executes each of steps configuring the learning processing S and the machine review processing by using a plurality of computers configured to be capable of mutually communicating (for example, capable of parallel execution). An example thereof may be a mode where some or all of steps configuring the learning processing S are performed by using a host computer (server), and some or all of steps configuring the machine review processing are performed by using a client computer (terminal).

### (Learned Model)

The learned model M constructed by the learning processing S according to the embodiment is a model (algorithm) having each set of data Di included in the data set DS as input and scores Si indicating levels at which the data Di satisfy a predefined extraction condition as output. The learned model M is used when the computer 1 performs the machine review processing.

Note here that the machine review processing indicates processing executed by the computer 1 for calculating the scores Si of each set of data Di included in the data set DS by using the learned model M. Note that the scores Si may be the probability of satisfying the extraction condition. Further, the machine review processing may include processing for sorting the data D1, D2, . . . , Dn included in the data set DS in a descending order of scores S1, S2, . . . , Sn.

The computer 1 executes presentation processing for presenting the result of the above-described machine review processing (may be the scores S1, S2, . . . , Sn or may be a list on which the data D1, D2, . . . , Dn are sorted in a descending order of the scores S1, S2, . . . , Sn) to a user such as a reviewer. The presented result of the machine review is used when the reviewer performs human review, for example. Note here that “human review” means the work performed by the reviewer for extracting the data corresponding to the extraction condition from the data D1, D2, . . . , Dn included in the data set DS.

The reviewer becomes capable of performing the work efficiently by referring to the result of the machine review processing. While the method of using the result of the machine review processing is not specifically limited, examples thereof may be: (1) a method where the data Di having the scores Si that are equal to or larger than a predefined threshold value are taken as the subject of the work (the data Di having the scores Si less than the threshold value are excluded from the subject of the work); (2) a method where the work is performed on the data Di in a descending order of the scores Si; and (3) a method where the reviewer for performing the work on the data Di is determined according to the scores Si.

Note that human review may be configured with a primary review performed by a general (or low-expertise) reviewer and a secondary review performed by a specific (or high-expertise) reviewer. In such case, the secondary review may be work for extracting the data corresponding to the extraction condition from the data extracted in the primary review from the data included in the data set DS, for example. Alternatively, the secondary review may be work for determining whether or not the data sampled (for example, may be random sampling) from the data set DS corresponds to the extraction condition, and may be a sampling inspection for checking correctness of the primary review based on the result of such determination.

As an example, human review may be review work for extracting text data to be submitted to the United States Court from text data held by a litigant (custodian) in a discovery procedure of a civil suit in the United States. In such case, the text data relevant to the suit is treated as the data satisfying the above-described extraction condition. Further, in such case, the score Si calculated with the learned model M also indicates the level of relevancy between the data Di and the suit.

Note that the data Di configuring the data set DS may be any electronic data in a format that can be processed by the computer 1. For example, the data Di may be text data including a document written in a natural language. The text data may be structured data or unstructured data. An e-mail (including an attached file and a header text), a technical document (a document regarding technical matters such as academic paper, a patent publication, product specifications, a design, or the like), a presentation material, a spreadsheet material, a statement of accounts, a meeting material, various kinds of reports, a business sales material, a contract, an organization chart, a business operation plan, corporate analysis information, an electronic medical chart, a Web page (including a Web log), an article, a comment, and the like submitted on a social network service are examples of the text data.

Further, the data Di may also be image data. A photograph, an X-ray image, a CT (Computed Tomography) image, an MRI (Magnetic Resonance Imaging) image, and the like are examples of the image data. For example, when the data Di are X-ray images, an X-ray image including a focus as a subject is taken as the data satisfying the above-described extraction condition. Further, the data Di may also be audio data. Recorded data recording conversations, music, and the like is an example of the audio data. For example, when the data Di are the recorded data recording conversations, the recorded data recording conversations including a specific topic is taken as the data satisfying the above-described extraction condition, for example. Further, the data Di may also be video data. Recorded data recording scenery, movies, and the like is an example of video data. For example, when the data Di are the recorded data recording a movie, the recorded data recording the movie on which a specific player appears is taken as the data satisfying the above-described extraction condition, for example.

### (Learning Processing)

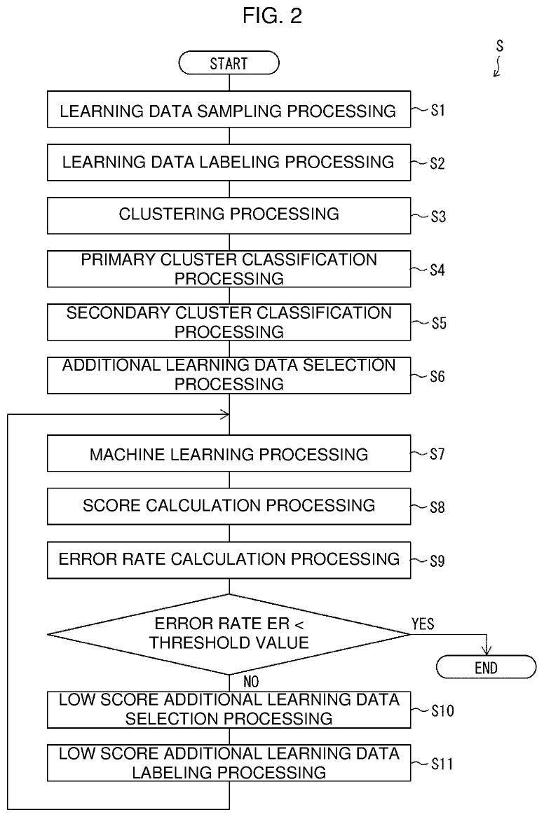

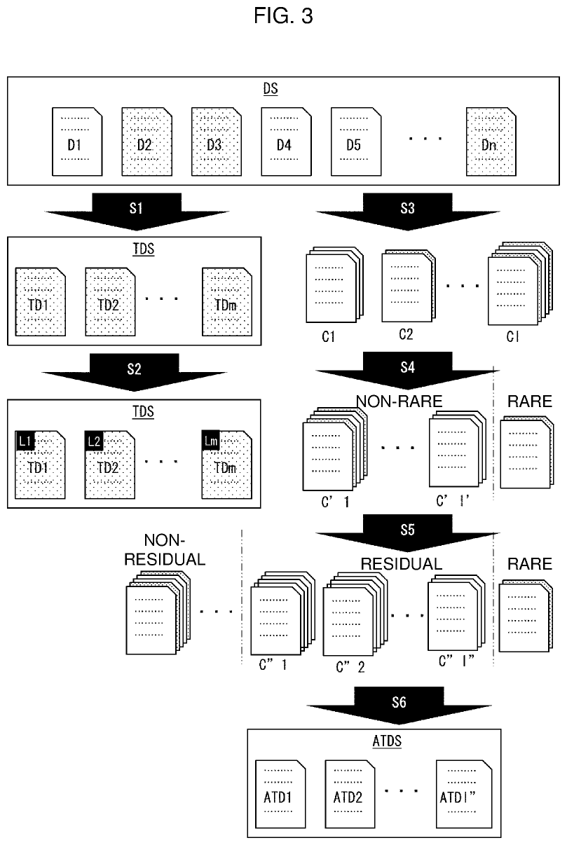

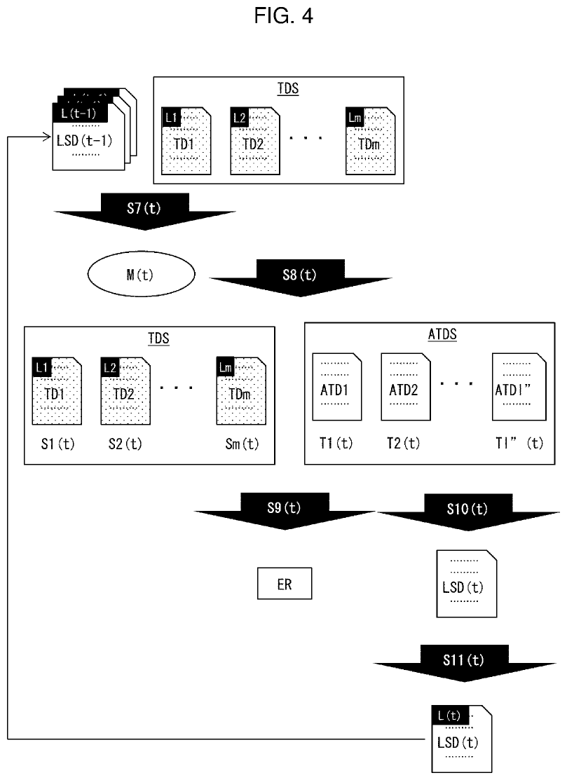

The learning processing S including configuration processing according to an embodiment of the disclosure will be described by referring to FIG. 2 to FIG. 4. FIG. 2 is a flowchart illustrating a flow of the learning processing S. FIG. 3 is a flowchart illustrating a flow of data in a first half of the learning processing S. FIG. 4 is a flowchart illustrating a flow of data in a latter half of the learning processing S.

The learning processing S is the processing for acquiring the learned model M having each set of data Di included in the data set DS as input and the scores Si indicating levels at which the data Di satisfy the predefined extraction condition as output. As illustrated in FIG. 2, the machine learning processing S includes learning data sampling processing S1, learning data labeling processing S2, clustering processing S3, primary cluster classification processing S4, secondary cluster classification processing S5, additional learning data selection processing S6, machine learning processing S7, score calculation processing S8, error rate calculation processing S9, low score additional learning data selection processing S10, and low score additional learning data labeling processing 11. Note that all of those kinds of processing S1 to S11 may be executed by the controller 12 of the computer 1 or may be executed by a plurality of controllers loaded on a plurality of respective computers (for example, may be executed in parallel).

### (Learning Data Sampling Processing S1)

The learning data sampling processing S1 is processing for sampling data of m-sets (m<n) defined in advance from the data set DS. Hereinafter, the data sampled in the learning data sampling processing S1 among the data D1, D2, . . . , Dn included in the data set DS will be written as learning data TDj (j=1, 2, . . . , m). The learning data TDj is an example of “first learning data” in a scope of appended claims. Further, a set of the learning data TD1, TD2, . . . , TDm is written as a learning data set TDS.

Note that the learning data set DS may also be referred to as a set of data for which the reviewer determines whether or not the predefined extraction condition is satisfied in the learning data labeling processing S2 to be described later, that is, “review data set.”

### (Learning Data Labeling Processing S2)

The learning data labeling processing S2 is processing for giving labels Lj indicating whether or not the data satisfies the predefined extraction condition to each of the learning data TDj included in the learning data set TDS. Whether or not each of the learning data TDj satisfies the extraction condition is determined by the reviewer (may be a general or low-expertise reviewer or may be a specific or a high-expertise reviewer, however, it is desirable to be the latter).

That is, for example, the computer 1 requests the reviewer to determine whether or not the extraction condition is satisfied, and gives a label according to the determination result of the reviewer. Alternatively, the host computer requests the reviewer to determine whether or not the extraction condition is satisfied, and the client computer gives a label according to the determination result of the reviewer.

The labels Lj are binary labels, for example, and take a value “1” when the learning data TDj satisfy the extraction condition while taking a value “0” when the learning data TDj do not satisfy the extraction condition. Further, the labels Lj may be multi-value labels. In such case, a plurality of extraction conditions are set, for example, and the labels Lj take a value according to the corresponding extraction condition such as taking a value “1” when a first extraction condition is satisfied and taking a value “2” when a second extraction condition is satisfied.

### (Clustering Processing S3)

The clustering processing S3 is processing for clustering the data D1, D2, . . . , Dn included in the data set DS. The clustering processing S3 is executed as follows, for example. First, each set of the data Di included in the data set DS is expressed with vectors Vi (elements of a vector space E defined in advance). Then, the data D1, D2, . . . , Dn included in the data set DS are clustered based on layout of the vectors V1, V2, . . . , Vn in the vector space E. That is, the data D1, D2, . . . , Dn are clustered such that the data Di, Di′ of small distance d (Vi, Vi′) between the corresponding vectors Vi, Vi′ belong to a same cluster and that, inversely, the data Di, Di′ of large distance d (Vi, Vi′) between the corresponding vectors Vi, Vi′ belong to different clusters.

Note that the distance d may be a Euclidean distance or may be a cosine distance. Hereinafter, the clusters acquired in the clustering processing S3 will be written as cluster Ck (k=1, 2, . . . , 1). Note here that “1” is the number of clusters acquired in the clustering processing S3. Note that the algorithm described herein is merely an example of algorithm that can be used for the clustering processing. Any algorithm can be used for the clustering processing as long as it is a well-known algorithm for classifying data. For example, the clustering processing may be hierarchical clustering processing or may be non-hierarchical clustering processing. Further, the clustering processing may be discrete clustering processing or may be continuous clustering processing. Further, the clustering processing may also be processing other than the clustering processing based on the distance, such as clustering processing based on grid division of a hyperplane, for example.

### (Supplement Regarding Data Vectorization)

When the data Di are document data, vectors acquired by arranging the number of appearance times of a prescribed word in a text expressed by the data Di, TF values, TF/IDF values in a prescribed order can be used as the vectors expressing the data Di. Alternatively, a vector arranging a prescribed feature amount of a text expressed by the data Di in a prescribed order can be used as a vector Vi expressing the data Di. Examples of the feature amount of a document may be feature amounts indicating complication of a text such as type, the number of parts of speech, TTR (Type Token Ratio), CTTR (Corrected Type Token Ratio), Yule's K, the number of dependency, numerical value ratios, and feature amounts indicating the size of the text such as the number of characters, the number of words, the number of sentences, the number of paragraphs.

Note that TF value tf(t,d) of a lexis t in data d can be calculated by a following expression (1), for example. Note here that “nt,d” expresses the number of appearance times of the term t in the data d, “Σs∈dns,d” expresses the sum total of the number of appearance times “ns,d” in the data d of each lexis s included in the data d. Further, TF-IDF value “TF-IDF(t,d)” of the lexis t in the data d can be calculated by following expressions (2) and (3), for example. Note here that “N” is the total sets of data, and “df(t)” is the total sets of data including the lexis t.

$$\begin{matrix}[ Expression 1 ] & \\ tf ( t , d ) = \frac{{n}_{t , d}}{{\sum }_{s ∈ d} {n}_{s , d}} & ( 1 ) \\ [ Expression 2 ] & \\ idf ( t ) = log \frac{N}{df ( t )} + 1 & ( 2 ) \\ [ Expression 3 ] & \\ TF \cdot IDF ( t , d ) = tf ( t , d ) \times idf ( t ) & ( 3 )\end{matrix}$$

Further, when the data Di are image data, vectors acquired by arranging pixel values of an image expressed by the data Di in a prescribed order may be used as the vectors Vi expressing the data Di, for example. Alternatively, vectors acquired by arranging prescribed feature amounts of the images expressed by the data Di in a prescribed order may be used as the vectors Vi expressing the data Di. Further, when the data Di are audio data, vectors acquired by arranging wave highest values of sound waves expressed by the data Di in a prescribed order may be used as the vectors Vi expressing the data Di. Alternatively, vectors acquired by arranging prescribed feature amounts of the sound waves expressed by the data Di in a prescribed order may be used as the vectors Vi expressing the data Di.

### (Primary Cluster Classification Processing S4)

The primary cluster classification processing S4 is processing for classifying the clusters C1, C2, . . . , C1 into rare clusters and non-rare clusters according to the number of sets of data belonging to each cluster Ck. Note here that the rare cluster of a certain cluster Ck may be a cluster where the number of sets of data belonging to the cluster Ck is less than a predefined threshold value (for example, 3), for example. Also, the non-rare cluster of a certain cluster Ck may be a cluster where the number of sets of data belonging to the cluster Ck is equal to or larger than the threshold value, for example.

Hereinafter, based on the example above, the cluster classified as the non-rare cluster from the clusters C1, C2, . . . , C1 by the primary cluster classification processing S4 is written as non-rare cluster C′k (k=1, 2, . . . , 1′). Note here that “1′ (1′≤1)” is the number of clusters classified as the non-rare clusters in the primary cluster classification processing S4. Note that the rare cluster is not used in the processing thereinafter and is the subject of human review. It is because the data included in the rare cluster is highly possible to be a noise, so that the use of the rare cluster as the learning data may rather deteriorate the generalization capability of the learned model M.

### (Secondary Cluster Classification Processing S5)

The secondary cluster classification processing S5 is processing for classifying the non-rare clusters C′1, C′2, . . . , C′1′ to a residual cluster and a non-residual cluster depending on whether or not each of the non-rare clusters C′k includes the learning data TDj. Note here that “a certain non-rare cluster C′k is the residual cluster” means that the certain non-rare cluster C′k does not include the learning data TDj included in the learning data set TDS. Further, “a certain non-rare cluster C′k is the non-residual cluster” means that the certain non-rare cluster C′k includes the learning data TDj included in the learning data set TDS.

Hereinafter, the cluster classified as the residual cluster from the non-rare clusters C′1, C′2, . . . , C′1′ by the secondary cluster classification processing S5 is written as residual cluster C″k (k=1, 2, . . . , 1″). Note here that “1″ (1″≤1′)” is the number of clusters classified as the residual clusters in the secondary cluster classification processing S5.

### (Additional Learning Data Selection Processing S6)

The additional learning data selection processing S6 is processing for selecting at least one set of data from each of the residual clusters C″k. The data selected by the additional learning data selection processing S6 may be data selected manually by a user (for example, a reviewer) or may be data automatically selected (for example, randomly sampled) by the computer 1.

Hereinafter, the data selected by the additional learning data selection processing S6 will be written as additional learning data ATDk (k=1, 2, . . . , 1″). The additional learning data ATDk is an example of “second learning data” in a scope of the appended claims. Further, a set of additional learning data ATD1, ATD2, . . . , ATD1′ will be written as an additional learning data set ATDS.

### (Repeat)

The computer 1 may repeat the machine learning processing S7, the score calculation processing S8, the error rate calculation processing S9, the low score additional learning data selection processing S10, and the low score additional learning data labeling processing S11 described hereinafter, for example, until an error rate ER calculated by the error rate calculation processing S9 becomes less than a predefined threshold value.

In the description hereinafter, a variable t indicating the number of execution times of such processing S7 to S11 is introduced, and (t) is added to the end of reference sign of t-th processing. For example, the machine learning processing S7(1) indicates the machine learning processing S7 executed for the first time, and the machine learning processing S7(2) indicates the machine learning processing executed for the second time. Further, the learned model M acquired by the t-th machine learning processing S7(t) is written as a model M(t).

### (Machine Learning Processing S7)

The first machine learning processing S7(1) is processing for configuring supervised data (an example of “learning data set” in a scope of the appended claims) with (a) learning data TD1, TD2, . . . , TDm sampled by the learning data sampling processing S1 and (b) labels L1, L2, . . . , Lm given by the learning data labeling processing S2, and constructing a learned model M(1) by using the supervised data.

Meanwhile, the t-th (t is a natural number of 2 or larger) machine learning processing S7(t) is processing for configuring supervised data (an example of “learning data set” in a scope of the appended claims) with (a) learning data TD1, TD2, . . . , TDm sampled by the learning data sampling processing S1, (b) labels L1, L2, . . . , Lm given by the learning data labeling processing S2, (c) low score additional learning data LSD(1), LSD(2), . . . , LSD(t−1) selected by the 1st to (t−1)-th low score learning data selection processing S10(1), S10(2), . . . , S10(t−1), and (d) labels L(1), L(2), . . . , L(t−1) given by the 1st to (t−1)-th low score learning data labeling processing S11(1), S11(2), . . . , S11(t−1), and constructing a learned model M(t) by using the supervised data.

### (Score Calculation Processing S8)

The t-th (t is a natural number of 1 or larger) score calculation processing S8(t) is processing for calculating scores Sj of each of learning data TDj included in the learning data set TDS by using the learned model M(t) acquired by the t-th machine learning processing S7(t), and calculating scores Tk of each set of the additional learning data ATDk included in the additional learning data set ATDS.

After executing the first score calculation processing S8(1), presentation processing may be executed for presenting the result of sorting the learning data TD1, TD2, . . . , TDm and the additional learning data ATD1, ATD2, . . . , ATD1″ according to the calculated scores S1(1), S2(1), . . . , Sm(1) and scores T1(1), T2(1), . . . , T1″(1) to the user. The presentation processing may be achieved by outputting the title list of the learning data TD1, TD2, . . . , TDm and the additional learning data ATD1, ATD2, . . . , ATD1″ arranged in a descending order of the scores S1(1), S2(1), . . . , Sm(1) and the scores T1(1), T2(1), . . . , T1″(1) to the output device 3 (for example, a display) by the controller 12 of the computer 1, for example.

### (Error Rate Calculation Processing S9)

The t-th (t is a natural number of 1 or larger) error rate calculation processing S9 is processing for calculating the error rate ER of the learned model M(t) by referring to the scores S1(t), S2(t), . . . , Sm(t) of the learning data TD1, TD2, . . . , TDm and the scores T1(t), T2(t), . . . , T1′(t) of the additional learning data ATD1, ATD2, . . . , ATD1′ acquired in the t-th score calculation processing S8(t). Herein, it is considered an error when the scores Sj of the learning data TDj whose labels Lj are 1 (satisfies the extraction condition) are equal to or lower than a predefined threshold value Th, for example.

In such case, the error rate ER is calculated from “ER=A/(A+B+C)” where “A” is the number of sets of learning data TDj whose labels Lj are 1 and scores Sj are equal to or less than the threshold value Th, “B” is the number of sets of learning data TDj whose labels Lj are 0 and scores Sj are equal to or less than the threshold value Th, and “C” is the number of sets of additional learning data ATDk whose scores Tk are equal to or less than the threshold value Th, for example. When the error rate ER calculated by the t-th error rate calculation processing S9(t) is less than the predefined threshold value, the machine review processing described above is executed by using the learned model M=M(t).

### (Low Score Additional Learning Data Selection Processing S10)

The t-th (t is a natural number of 1 or larger) low score additional learning data selection processing S10(t) is processing for selecting at least one set of additional learning data ATDk of low score Tk from the additional learning data set ATDS. Note, however, that the additional learning data ATDk selected by the 1st to (t−1)-th low score additional learning data selection processing S10(1), S10(2), . . . , S10(t−1) is not to be selected by the t-th low score additional learning data selection processing S10(t).

Hereinafter, the additional learning data selected by the t-th low score additional learning data selection processing S10(t) from the additional learning data ATD1, ATD2, . . . , ATD1″ included in the additional learning data set ATDS will be written as low score additional learning data LSD(t). In the low score additional learning data selection processing S10, the predefined number of sets of additional learning data may be selected in order from the lower score or the predefined number of sets of additional learning data may be randomly selected from the additional learning data having the score that is equal to or lower than a predefined threshold value.

### (Low Score Additional Learning Data Labeling Processing S11)

The t-th (t is a natural number of 1 or larger) low score additional learning data labeling processing S11 is processing for giving a label L(t) indicating whether or not the predefined extraction condition is satisfied to the low score additional learning data LSD(t) selected by the t-th low score additional learning data selection processing S10(t).

Whether or not the low score additional learning data LSD satisfies the extraction condition is determined by the reviewer (human) (the computer requests the reviewer to determine whether or not the extraction condition is satisfied, and gives a label according to the determination result of the reviewer). The label L(t) is a binary label, and takes a value 1 when the low score additional learning data LSD(t) satisfies the extraction condition while taking a value 0 when the low score additional learning data LSD(t) does not satisfy the extraction condition, for example.

Note that a learning data set creation routine (the learning data sampling processing S1 and the learning data labeling processing S2) and the additional learning data set creation routine (the clustering processing S3, the primary cluster classification processing S4, the secondary cluster classification processing S5, and the additional learning data selection processing S6) are mutually independent. Therefore, the additional learning data creation routine may be executed after executing the learning data set creation routine, the learning data set creation routine may be executed after executing the additional learning data set creation routine, or the learning data creation routine and the additional learning data creation routine may be performed in parallel.

Further, the above-described extraction condition may be configured from a plurality of viewpoints to be the basis of determining whether or not each set of the data Di included in the data set DS satisfies the extraction condition. For example, when the extraction condition includes viewpoints of K1, K2, . . . , Kn (n is a natural number indicating the number of viewpoints), clusters are generated to correspond to each of the viewpoints when the computer 1 performs clustering of the data set. Therefore, unlabeled data included in each of the clusters includes the viewpoint corresponding to the cluster. However, it is an ideal case, and there is a possibility that unlabeled data including a certain viewpoint is mistakenly clustered to the cluster corresponding to another viewpoint. Further, there may be a case where a single set of unlabeled data includes a plurality of viewpoints. In such case, there is a possibility that such unlabeled data is clustered to a single cluster corresponding to the viewpoint.

The computer 1 samples the unlabeled data as the review data set from the data set, and clusters the unlabeled data included in the data set (the order of the sampling processing and the clustering processing may be inverted). Then, when the data included in a certain cluster is not included in the review data set even though the number of sets of data included in the certain cluster is large to some extent, the computer 1 adds the data included in the cluster to the review data set.

In other words, the computer 1 can supplement the unlabeled data to the learning data set TDS to decrease omission of the viewpoints of the unlabeled data (data not included in the learning data set TDS) included at least in a part of the clusters C1, C2, . . . , C1, for example. In such case, the learning data set for constructing the learned model M may be configured through giving a label to each set of the unlabeled data by the reviewer (in other words, the computer 1 gives the label determined according to determination of the reviewer) based on whether or not the supplemented unlabeled data satisfies the extraction condition.

### (Summary)

The computer according to a first aspect of the disclosure is a computer configuring a learning data set used for machine learning, the computer including a memory and a controller, wherein: the memory includes a data set stored therein; and the controller executes sampling processing for sampling first learning data from the data set, clustering processing for generating a plurality of clusters by clustering data included in the data set, selection processing for selecting second learning data from the cluster not including the first learning data among the plurality of clusters, and configuration processing for configuring a learning data set including the first learning data and at least a part of the second learning data as the learning data set.

With the above-described configuration, it is possible to configure the learning data set including at least a part of the second learning data selected from the cluster not including the first learning data in addition to the first learning data selected by random sampling. Thus, for example, compared to the learning data set configured with the randomly sampled learning data, the learning data set of higher diversity can be configured. Therefore, through performing machine learning using the learning data set acquired by the above-described configuration, it is possible to construct the learned model exhibiting a sufficiently high generalization capability. Particularly, even in a case where a sufficient number of sets of learning data cannot be collected, it is possible to construct the learned model exhibiting a sufficiently high generalization capability through performing machine learning using the learning data set acquired by the above-described configuration.

Note that the learning data set acquired by the above-described configuration may be used for constructing the learned model for performing specific information processing (inference) requested by a client, for example. In such case, there is a tendency that it is difficult to have consent of the client for the result of the information processing by the learned model unless the learning data is collected thoroughly from the subject area where the learned model is to exhibit the generalization capability. With the configuration described above, constructed is the learning data set including not only the first learning data extracted by the sampling processing but also the second learning data selected from the cluster not including the data extracted by the sampling processing. Therefore, there is also expected such a subsidiary effect that the consent of the client for the result of the information processing by the learned model can be acquired easily.

In the computer according to a second aspect of the disclosure in the first aspect, the selection processing is preferably processing for selecting the second learning data from a cluster not including the first learning data among the plurality of clusters, the cluster having data of the number of sets exceeding a predefined threshold number (a threshold value compared with the number of sets) included therein.

With the above-described configuration, the second learning data selected from the cluster having a relatively greater number of sets of data is incorporated into the learning data set. Therefore, it is possible to avoid deterioration in the diversity of the learning data set, which may be caused when even one set of data included in the cluster having a relatively great number of sets of data is not incorporated into the learning data set. Therefore, with the above-described configuration, the learning data set of still higher diversity can be configured. Note that “the number of sets exceeds the threshold number” means that the number of sets is equal to or more than the threshold number or the number of sets is larger than the threshold number.

In the computer according to a third aspect of the disclosure in the first or second aspect, the controller preferably further executes score calculation processing for calculating scores of the first learning data and the second learning data by using a learned model having data included in the data set as input and having a score indicating a level at which the data satisfies a predefined extraction condition as output, the learned model being constructed by machine learning using the learning data set; and the configuration processing is preferably processing for configuring the learning data set including the first learning data and the second learning data having the score that falls below a predefined first threshold score (a threshold value compared with the score).

With the above-described configuration, the second learning data of relatively low score that is calculated by the already learned model is incorporated into the learning data set. That is, the data whose importance cannot be captured with the already learned model is to be incorporated into the learning data. Therefore, with the above-described configuration, the learning data set of still higher diversity can be configured. Note that “the score falls below the first threshold score” means that the score is equal to or less than the first threshold score or the score is smaller than the first threshold score.

In the computer according to a fourth aspect of the disclosure in any one of the first to third aspect, the controller preferably further executes labeling processing for giving a specific label to the first learning data satisfying a predefined extraction condition according to an instruction of a user, score calculation processing for calculating scores of the first learning data and the second learning data by using a learned model having data included in the data set as input and having a score indicating a level at which the data satisfies the extraction condition as output, the learned model being constructed by machine learning using the learning data set, and error rate calculation processing for calculating an error rate of the learned model according to the number of sets of the first learning data having the score that falls below a predefined second threshold score (a threshold value compared with the score, and may be the same with or different from the first threshold score), the first learning data having the label given thereto; and to repeat the configuration processing by adding new second learning data to the learning data set until the error rate falls below a predefined threshold value.

With the above-described configuration, it is possible to configure the learning data set capable of constructing the learned model with which there is a sufficiently small possibility of giving a low score to the data determined to satisfy the predefined extraction condition by the reviewer. Note that “the score falls below the second threshold score” means that the score is equal to or less than the second threshold score or the score is smaller than the second threshold score. Further, “the error rate falls below the threshold value” means that the error rate is equal to or less than the threshold value or the error rate is smaller than the threshold value.

In the computer according to a fifth aspect of the disclosure in any one of the first to fourth aspects, the selection processing is preferably processing for selecting the second learning data designated by a user from a cluster not including the first learning data among the plurality of clusters.

With the above-described configuration, it is possible to incorporate the data which, from the cluster not including the first learning data, is determined by the user to have an especially high effect for increasing the diversity of the learning data set into the learning data set. Therefore, with the above-described configuration, the learning data set of still higher diversity can be configured.

In the computer according to a sixth aspect of the disclosure in any one of the first to fifth aspects, the controller preferably further executes: score calculation processing for calculating scores of the first learning data and the second learning data by using a learned model having data included in the data set as input and having a score indicating a level at which the data satisfies a predefined extraction condition as output, the learned model being constructed by machine learning using an initial learning data set configured with the first learning data; and presentation processing for presenting, to a user, the scores or a result of sorting the first learning data and the second learning data according to the scores.

With the above-described configuration, the user can efficiently perform human review for extracting the data satisfying the extraction condition, for example, by referring to the scores or the result of sorting the first learning data and the second learning data according to the scores.

In the computer according to a seventh aspect of the disclosure in any one of the first to sixth aspects, the data set preferably includes data to be a subject of human review to extract data satisfying a predefined extraction condition; and the controller preferably further executes machine review processing for calculating scores of each set of data included in the data set by using a learned model having data included in the data set as input and having a score indicating a level at which the data satisfies the extraction condition as output, the learned model being constructed by machine learning using the learning data set.

With the above-described configuration, it is possible to perform machine review of the data set by using the learned model exhibiting a sufficiently high generalization capability.

The configuration method according to an eighth aspect of the disclosure is a configuration method for configuring a learning data set used for machine learning by using a computer including a memory storing a data set and a controller, the method including: sampling processing executed by the controller for sampling first learning data from the data set; clustering processing executed by the controller for generating a plurality of clusters by clustering data included in the data set; selection processing executed by the controller for selecting second learning data from the cluster not including the first learning data among the plurality of clusters; and configuration processing executed by the controller for configuring a learning data set including the first learning data and at least a part of the second learning data as the learning data set.

With the above-described configuration, it is possible to configure the learning data set including at least a part of the second learning data selected from the cluster not including the first learning data in addition to the first learning data selected by random sampling. Therefore, it is possible to configure the learning data set of higher diversity compared to the learning data set configured with the learning data selected by sampling. Therefore, even in a case where a sufficient number of sets of learning data cannot be collected, it is possible to construct the learned model exhibiting a sufficiently high generalization capability through performing machine learning using the learning data set acquired by the above-described configuration.

Note that a program for operating the computer to execute the sampling processing, the clustering processing, the selection processing, and the configuration processing and also a computer readable recording medium that records such program are also included in the scope of the disclosure.

In the computer according to a tenth aspect of the disclosure is a computer configuring a learning data set for learning a model, the computer including a memory and a controller, wherein: the memory stores a data set; the data set includes at least a part of sets of unlabeled data having no label indicating whether or not a prescribed extraction condition is satisfied; the prescribed extraction condition is configured from a plurality of viewpoints to be a basis of determining whether or not the data satisfies the extraction condition; and the controller executes processing for configuring a review data set by sampling the unlabeled data from the data set, processing for generating a plurality of clusters by clustering the data included in the data set, and processing for supplementing the unlabeled data included at least in a part of the plurality of clusters to the review data set so as to decrease omission of the viewpoints.

The method according to an eleventh aspect of the disclosure is a method for configuring the learning data set for learning the model by using the computer of the tenth aspect, the method including giving the label to each set of the unlabeled data by a reviewer based on whether or not the unlabeled data included in the supplemented review data set satisfies the prescribed extraction condition to configure the learning data set for learning the model.

With the above-described configuration, omission of the viewpoints can be decreased so that it is possible to configure the review data set where the diversity of the viewpoints is secured compared to that of the review data set configured with the review data randomly sampled, for example. Through reviewing the data set by the reviewer and giving the label to configure the learning data set, the learned model exhibiting a high generalization capability can be constructed. Particularly, even when the volume of the learning data is insufficient, a model exhibiting a high generalization capability can be acquired.

This application claims the benefit of foreign priority to Japanese Patent Applications No. JP2018-237649, filed Dec. 19th, 2018, which is incorporated by reference in its entirety.

What is claimed is:

1. A computer configuring a learning data set used for machine learning, the computer comprising a memory and a controller, wherein:
the memory includes a data set stored therein; and
the controller executes
sampling processing for sampling first learning data from the data set,
clustering processing for generating a plurality of clusters by clustering data included in the data set,
selection processing for selecting second learning data from a cluster not including the first learning data among the plurality of clusters, and
configuration processing for configuring a learning data set including the first learning data and at least a part of the second learning data as the learning data set.

2. The computer according to claim 1, wherein, in the selection processing, the second learning data is selected from the cluster not including the first learning data among the plurality of clusters, the cluster having data of the number of sets exceeding a predefined threshold number included therein.

3. The computer according to claim 1, wherein:
the controller further executes score calculation processing for calculating scores of the first learning data and the second learning data by using a learned model having data included in the data set as input and having a score indicating a level at which the data satisfies a predefined extraction condition as output, the learned model being constructed by machine learning using the learning data set; and
in the configuration processing, the learning data set is configured including the first learning data and the second learning data having the score that falls below a predefined first threshold score.

4. The computer according to claim 1, wherein the controller:
further executes
labeling processing for giving a specific label to the first learning data satisfying a predefined extraction condition according to an instruction of a user,
score calculation processing for calculating scores of the first learning data and the second learning data by using a learned model having data included in the data set as input and having a score indicating a level at which the data satisfies the extraction condition as output, the learned model being constructed by machine learning using the learning data set, and
error rate calculation processing for calculating an error rate of the learned model according to the number of sets of the first learning data having the score that falls below a predefined second threshold score, the first learning data having the label given thereto; and
repeats the configuration processing by adding new second learning data to the learning data set until the error rate falls below a predefined threshold value.

5. The computer according to claim 1, wherein, in the selection processing, the second learning data designated by a user is selected from the cluster not including the first learning data among the plurality of clusters.

6. The computer according to claim 1, wherein the controller further executes:
score calculation processing for calculating scores of the first learning data and the second learning data by using a learned model having data included in the data set as input and having a score indicating a level at which the data satisfies a predefined extraction condition as output, the learned model being constructed by machine learning using an initial learning data set configured with the first learning data; and
presentation processing for presenting, to a user, the scores or a result of sorting the first learning data and the second learning data according to the scores.

7. The computer according to claim 1, wherein:
the data set includes data to be a subject of human review with which a reviewer extracts data satisfying a predefined extraction condition; and
the controller further executes machine review processing for calculating scores of each set of data included in the data set by using a learned model having data included in the data set as input and having a score indicating a level at which the data satisfies the extraction condition as output, the learned model being constructed by machine learning using the learning data set.

8. A configuration method for configuring a learning data set used for machine learning by using a computer comprising a memory storing a data set and a controller, the method comprising:
sampling processing executed by the controller for sampling first learning data from the data set;
clustering processing executed by the controller for generating a plurality of clusters by clustering data included in the data set;
selection processing executed by the controller for selecting second learning data from a cluster not including the first learning data among the plurality of clusters; and
configuration processing executed by the controller for configuring a learning data set including the first learning data and at least a part of the second learning data as the learning data set.

9. A computer configuring a learning data set for learning a model, the computer comprising a memory and a controller, wherein:
the memory stores a data set that includes at least a part of sets of unlabeled data having no label indicating whether or not a prescribed extraction condition is satisfied wherein the prescribed extraction condition is configured from a plurality of viewpoints to be a basis of determining whether or not the data satisfies the extraction condition; and
the controller executes
processing for configuring a review data set by sampling the unlabeled data from the data set,
processing for generating a plurality of clusters by clustering the data included in the data set, and
processing for supplementing the unlabeled data included at least in a part of the plurality of clusters to the review data set so as to decrease omission of the viewpoints.

10. A method for configuring the learning data set for learning the model by using the computer according to claim 9, the method comprising
giving the label to each set of the unlabeled data by a reviewer based on whether or not the unlabeled data included in the supplemented review data set satisfies the prescribed extraction condition to configure the learning data set for learning the model.
